(19) United States
(12) Patent Application Publication
(10) Pub. No.: US 2013/0278069 A1
(43) Pub. Date: Oct. 24, 2013

(54) POWER SUPPLY SYSTEM

(71) Applicant: SMK CORPORATION, Tokyo (JP)

(72) Inventors: Toshihiro AMEI, Kanagawa (JP); Haruhiko KONDO, Kanagawa (JP)

(73) Assignee: SMK CORPORATION, Tokyo (JP)

(21) Appl. No.: 13/792,236

(22) Filed: Mar. 11, 2013

(30) Foreign Application Priority Data
Apr. 19, 2012 (JP) 2012-095259

(51) Int. Cl. G05F 1/46

(52) U.S. Cl. CPC G05F 1/462
USPC 307/103

(57) ABSTRACT

Provided is a power supply system which is capable of controlling a power receive device to have an input voltage or an input current at a predetermined input setting value even when a power supply device and the power receive device are connected to each other with an arbitrary power cable. The power receive device detects the input voltage or the input current inputted through the power cable and transmits a detected input voltage or input current as power-receive side information to the power supply device through the power cable. The power supply device controls the output value of an output voltage or an output current to be outputted to the power cable based on the power-receive side information received through the power cable so that the input voltage or the input current to be inputted to the power receive device is converged on a predetermined input setting value.

### CROSS REFERENCE TO RELATED APPLICATION

The contents of the following Japanese patent application are incorporated herein by reference,
NO. 2012-095259 filed on Apr. 19, 2012.

### BACKGROUND

1. Technical Field

The present invention relates to a power supply system which supplies power to a load connected to a power receive device through a power cable from a power supply device.

2. Description of the Related Art

Power supply devices which can output power equal to or greater than the rated power of loads are required to supply power to the loads within the range of the rated voltage and the rated current specified for each of the loads. A conventionally known power supply system monitors the output voltage and the output current between the output lines of a power supply device connected to a load and controls the output voltage and the output current at a predetermined output value which fits the rated voltage and the rated current of the load (Japanese Patent Application Publication No. 2002-136116).

However, even when the output from the power supply device is provided with constant-voltage and constant-current control to have a predetermined output value, the input voltage to the power receive device connected to the load may vary with the resistance of the power cable connecting between the power supply device and the power receive device and thus cannot be precisely controlled to the rated voltage of the load. Furthermore, when a plurality of power supply devices operate in parallel or when a power supply device is connected to a plurality of power receive devices, the input current to the power receive device cannot be controlled to fall within a rated current range even when the output current from the power supply device is controlled at a predetermined output value.

In this context, a power supply system 100 has been suggested which compensates for a voltage drop on the power cable connecting between a direct current (DC) power supply device and a load (the power receive device) so as to maintain the input voltage of the load at a predetermined input value (Japanese Patent Application Publication No. 5-49163).

Now, a description will be made to the conventional power supply system 100 with reference to FIG. 4. The power supply system 100 includes an alternating current (AC) transformer 101, a rectifier 102 for rectifying AC to DC, a gate controller 103 for controlling the output voltage from the rectifier 102, a DC transformer 106 for detecting an output current flowing through a power cable 105 connecting between the rectifier 102 and a load 104, and a voltage drop compensator 107 for outputting a correction voltage signal to the gate controller 103.

The voltage drop compensator 107 calculates the voltage drop on the power cable 105 by multiplying the output current flowing through the power cable 105 and detected by the DC transformer 106 by the resistance value of the power cable 105, and then outputs a correction voltage signal based on the voltage drop to the gate controller 103. The gate controller 103 compares the output voltage reduced by the voltage drop with a reference voltage to provide constant-voltage control to the output voltage from the rectifier 102. Thus, the load 104 is supplied with DC power at the reference voltage which is set on the power supply device side in consideration of the voltage drop across the power cable 105.

According to the aforementioned conventional power supply system 100, the input voltage to the load can be provided with constant-voltage control to have a predetermined voltage so long as the power cable 105 to be used has a known resistance value. However, in general, users who wish to connect the load 104 to the power supply device often do not know the resistance value of the power cable 105 or even if they do, the resistance value has to be entered to the voltage drop compensator 107.

Furthermore, assuming that the power cable 105 to be used has a known resistance value, the resistance value may be set in advance to the voltage drop compensator 107. Even in this case, the user may connect a power cable of a different length or different type to the load 104. This may cause the voltage drop calculated by the voltage drop compensator 107 to differ from the voltage drop across the actual power cable, so that an input voltage different from the rated voltage is applied to the load 104.

On the other hand, when a plurality of power receive devices are connected in parallel, the input current to an individual power receive device cannot be detected from the output current from the power supply device. Thus, even when the input current to a specific power receive device exceeded the rated current, the output current from the power supply device could not be reduced.

### SUMMARY

The present invention was developed in view of the aforementioned problems. It is therefore an object of the present invention to provide a power supply system which is capable of controlling the input voltage or input current to a power receive device to be at a predetermined input setting value even when a power supply device and the power receive device are connected to each other with an arbitrary power cable.

Furthermore, it is another object of the present invention to provide a power supply system which controls the input current to an individual power receive device to fall within a rated current range even when a plurality of power supply devices are operated in parallel or a power supply device is connected to a plurality of power receive devices.

Furthermore, it is still another object of the present invention to provide a power supply system which controls the input voltage or the input current to a power receive device to be at an optimum value according to the operation environment of a load.

To achieve the aforementioned objects, a power supply system according to a first aspect of the present invention supplies power to a load connected to a power receive device through a power cable connected between a power supply device and the power receive device. The power supply system is characterized in that the power receive device includes input detection means for detecting an input voltage or an input current inputted through the power cable, and power-receive side transmission means for transmitting the input voltage or the input current detected by the input detection means to the power supply device through the power cable as power-receive side information, and in that the power supply device includes power supply side receive means for receiving the power-receive side information through the power cable, and an output control circuit for controlling, on the basis of the power-receive side information received by the power supply side receive means, an output value of the output voltage or the output current to be outputted to the power cable so that the input voltage or the input current to be inputted to the power receive device is converged on a predetermined input setting value.

The power-receive side information to be transmitted from the power receive device to the power supply device is transmitted through the power cable connected between the power supply device and the power receive device.

The output control circuit of the power supply device controls the output value of the output voltage or the output current on the basis of the power-receive side information on the input voltage or the input current to the power receive device received from the power supply side receive means so as to converge the input voltage or the input current to be inputted to the power receive device to a predetermined input setting value.

The power supply system according to a second aspect of the present invention is configured such that the power supply device further includes power supply side transmission means for transmitting power supply side information to the power receive device through the power cable, and the power receive device further includes power-receive side receive means for receiving the power supply side information through the power cable.

The power supply side information to be transmitted from the power supply device to the power receive device is transmitted through the power cable connected between the power supply device and the power receive device.

The power supply system according to a third aspect of the present invention is configured such that the power supply side information is load control information for controlling an operation of a load connected to the power receive device, and the power receive device controls the operation of the load connected to the power receive device on the basis of the load control information received by the power-receive side receive means.

The power receive device controls the power consumption of the load connected to the power receive device on the basis of the load control information received from the power-receive side receive means.

The power supply system according to a fourth aspect of the present invention is configured such that the power supply device is a DC-DC converter for supplying DC power to a load connected to the power receive device; the power-receive side transmission means outputs, to the power cable, a modulation signal modulated on the basis of the power-receive side information; and the power supply side receive means demodulates the power-receive side information from the modulation signal inputted through the power cable.

The modulation signal modulated on the basis of the power-receive side information is superimposed on the voltage from a DC power supply containing no frequency component and then transmitted to the power supply device. Thus, the power supply side receive means of the power supply device can demodulate the power-receive side information from the modulation signal with reliability even if the modulation signal is a weak signal reduced in amplitude.

The power supply system according to a fifth aspect of the present invention is configured such that the power receive device allows the power-receive side transmission means to transmit an environment value of an installation location, the environment value being detected by a sensor disposed in the vicinity of the load and included in the power-receive side information; and the output control circuit of the power supply device controls, on the basis of the power-receive side information containing the environment value, the output value of the output voltage or the output current so that the input voltage or the input current is converged on a predetermined input setting value.

In accordance with the environment value detected by the sensor in the vicinity of the load, the output value of the output voltage or the output current from the power supply device can be controlled so that the input voltage or the input current to the power receive device is at a predetermined input setting value.

The power supply system according to a sixth aspect of the present invention is configured such that the power supply device further includes storage means for storing control data for continually controlling the input setting value, and the output control circuit of the power supply device controls the output value of the output voltage or the output current so that sequence control is provided on the basis of the control data to the input setting value of the input voltage or the input current.

The input voltage or the input current to the power receive device is provided with the sequence control by the output control circuit of the power supply device, whereby the power supply device can provide the sequence control to the operation of the load connected to the power receive device.

According to the first aspect of the present invention, the power-receive side information is transmitted from the power receive device to the power supply device via the power cable through which power is supplied from the power supply device to the power receive device. It is thus possible to use an arbitrary power cable without providing an additional signal line between the power supply device and the power receive device, and allow the input voltage or the input current to the power receive device to be controlled to a predetermined input setting value even with any power cable connecting therebetween.

Furthermore, even when a plurality of power supply devices are operated in parallel or when the power supply device is connected to a plurality of power receive devices, the input current to an individual power receive device can be controlled to a predetermined input setting value.

According to the second aspect of the present invention, the power cable connected between the power supply device and the power receive device can be utilized to transmit, from the power supply device to the power receive device, the power supply side information such as the output capacity of the power supply device and a predetermined input setting value for the input voltage or the input current to the power receive device controlled by the power supply device.

According to the third aspect of the present invention, when the power consumption of the power receive device controlled on the basis of the input setting value exceeds the output capacity of the power supply device, the operation of the load connected to the power receive device can be controlled to reduce the power consumption of the power receive device, whereby the input voltage or the input current to the power receive device can be controlled to an input setting value that is re-set within the output capacity of the power supply device.

Furthermore, when the power supply device is connected to a plurality of power receive devices, the load control information can be transmitted along with the ID information for identifying an individual power receive device, whereby the power consumption of each power receive device can be controlled, so that the power consumption of all the power receive devices is less than the power outputted from the power supply device.

According to the fourth aspect of the present invention, the power-receive side information can be transmitted to the power supply device on a low-amplitude modulation signal which has less effects on a DC input voltage.

According to the fifth aspect of the present invention, the power supply device can control the operation of the load without providing the power receive device with a control circuit for operating the load on the basis of the environment value in the vicinity of the load. Accordingly, the power supply device supplies power to the power receive device depending on the operation of the load, without outputting unnecessary power to the power cable.

According to the sixth aspect of the present invention, the power supply device can continually provide precise control to the operation of the load connected to the power receive device on the basis of the environment value in the vicinity of the load.

### BRIEF DESCRIPTION OF THE DRAWINGS

FIG. 1 is a schematic view illustrating a power supply system 1 according to an embodiment of the present invention.

FIG. 2 is a block diagram illustrating a power supply device 2.

FIG. 3 is a block diagram illustrating a power receive device 3 and a load 4.

FIG. 4 is a block diagram illustrating a conventional power supply system 100.

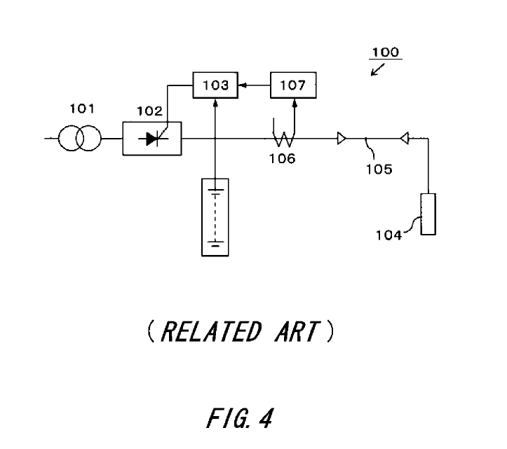

### DESCRIPTION OF EXEMPLARY EMBODIMENTS

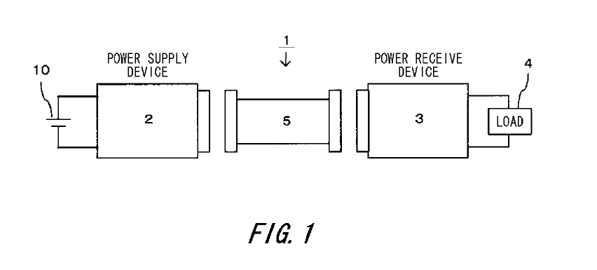

Now, a description will be made to a power supply system 1 according to an embodiment of the present invention with reference to FIGS. 1 to 3. As shown in FIG. 1, the power supply system 1 includes a power supply device 2 for outputting DC power, a power receive device 3 connected to a load 4 which operates on the DC power, and a power cable 5 which is made up of a pair of a higher-voltage connection line 5a and a lower-voltage connection line 5b so as to connect between the power supply device 2 and the power receive device 3.

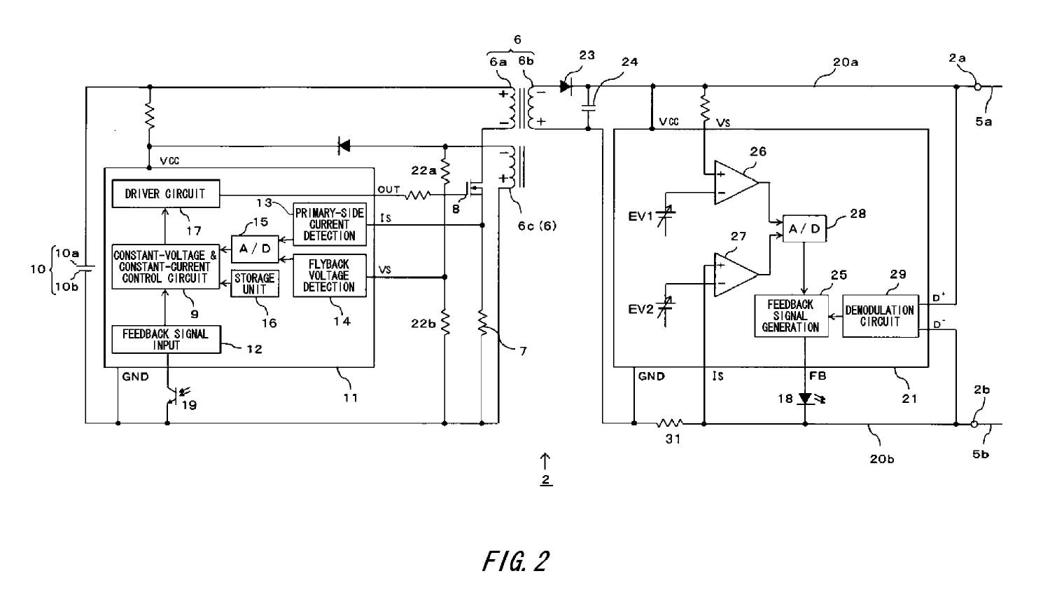

As shown in FIG. 2, the power supply device 2 according to this embodiment is a DC-DC converter for outputting unstable DC power, which may possibly vary in the voltage denoted by reference numeral 10 in the figure, to between a pair of output terminals 2a and 2b as DC power at a stable output voltage and current. More specifically, the power supply device 2 is a flyback-type DC-DC converter which discharges, as the output from a secondary winding 6b, the energy accumulated on a transformer 6 when the current flowing through a primary winding 6a of the transformer 6 is stopped.

The unstable DC power supply 10 shown in the figure provides a possibly varying voltage obtained by rectifying and smoothing commercial AC power, and is provided with a higher-voltage terminal 10a and a lower-voltage terminal 10b at ground potential. The transformer 6 is provided on the primary side thereof with a primary-side control circuit element 11 operating on the DC power 10, a MOSFET switching element 8 with the drain connected to one end of the primary winding 6a and the source connected to the lower-voltage terminal 10b through a primary current detection resistor 7, and a pair of potential divider resistors 22a and 22b which form a closed loop in conjunction with a feedback winding 6c of the transformer 6.

As illustrated, the primary-side control circuit element 11 is an IC element that includes the following which are integrated into a one-chip circuit component: a feedback signal input circuit 12; a primary-side current detection circuit 13; a flyback voltage detection circuit 14; an A/D converter 15; a storage unit 16; a constant-voltage & constant-current control circuit 9; and a driver circuit 17.

A feedback input FB to the feedback signal input circuit 12 is connected to a phototransistor 19 which is optically coupled to a photodiode 18 on the secondary side of the transformer 6. This allows a feedback signal produced by a feedback signal generation circuit 25 on the secondary side of the transformer 6 (to be discussed later) to be fed back to the feedback signal input circuit 12 via the feedback input FB through the photo-coupling elements 18 and 19.

The primary-side current detection circuit 13 has an analog input terminal Is which is connected to a connection point between the primary current detection resistor 7 and the switching element 8. The potential at the analog input terminal Is is expressed by the voltage drop across the primary current detection resistor 7 resulting from a primary winding current Ip through the primary winding 6a flowing therethrough. Thus, the primary-side current detection circuit 13 determines the primary winding current Ip by dividing the potential at the analog input terminal Is by the resistance value of the primary current detection resistor 7.

The flyback voltage detection circuit 14 has an analog input terminal Vs, which is connected to a connection point between the pair of potential divider resistors 22a and 22b, and is supplied with the higher-voltage potential of the potential divider resistor 22b. The pair of potential divider resistors 22a and 22b form a closed loop with the feedback winding 6c that is wound in the direction opposite to that of the primary winding 6a of the transformer 6. Thus, the flyback voltage detection circuit 14 is supplied with a negative potential from the analog input terminal Vs while the primary winding current Ip flows through the primary winding 6a, but with a positive potential while the primary winding current Ip has stopped and a flyback voltage occurs across each of the windings 6a, 6b, and 6c of the transformer 6, including the feedback winding 6c. That is, the flyback voltage detection circuit 14 makes use of the potential and the polarity at the analog input terminal Vs in order to monitor the status of the voltage established across each of the windings 6a, 6b, and 6c of the transformer 6.

Since the primary-side current detection circuit 13 and the flyback voltage detection circuit 14 supply an analog potential, the potential is binary coded by the A/D converter 15 and then supplied to the constant-voltage & constant-current control circuit 9 which performs computing on binary data. The constant-voltage & constant-current control circuit 9 is also supplied with sequence control data stored in the storage unit 16 and secondary side data expressed by a feedback signal from the feedback signal input circuit 12. The constant-voltage & constant-current control circuit 9 outputs, to the driver circuit 17, a control signal for providing ON-OFF control to the switching element 8 on the basis of these pieces of input data, which will be discussed later in greater detail.

The driver circuit 17 supplies its output “out” to the gate of the MOS-type FET or the switching element 8 through a resistor so as to provide ON/OFF control to the switching element 8 by applying a forward bias voltage to the gate with the timing indicated by a switch control signal being supplied, thereby providing oscillation control to the DC-DC converter 2 as a whole.

The transformer 6 is provided on the secondary side (output side) thereof with the following: a rectifier diode 23 and a smoothing capacitor 24, which constitute a rectifier smoothing circuit for rectifying and smoothing the output from the secondary winding 6b and supplying the resulting output between a higher-voltage output line 20a and a lower-voltage output line 20b; an output current detection resistor 31 which is connected in series to the lower-voltage output line 20b and has a micro resistance value; and a secondary side control circuit element 21 which operates on the output between the higher-voltage output line 20a and the lower-voltage output line 20b at the ground potential. The higher-voltage output line 20a and the lower-voltage output line 20b are connected to the higher-voltage connection line 5a and the lower-voltage connection line 5b of the power cable 5 at the output terminals 2a and 2b of the power supply device 2, respectively, so as to deliver the secondary side output from the transformer 6 under the constant-voltage and constant-current control.

The secondary side control circuit element 21 is an IC element that includes the following which are integrated into a one-chip circuit component: a voltage monitoring comparator 26 with the inverting input terminal connected to a first variable reference power supply EV1; a current monitoring comparator 27 with the inverting input terminal connected to a second variable reference power supply EV2; an A/D converter 28; a demodulation circuit 29; and the feedback signal generation circuit 25.

The voltage monitoring comparator 26 compares the voltage on the higher-voltage output line 20a supplied at the analog input terminal Vs with a first reference voltage delivered from the first variable reference power supply EV1 and then outputs the resulting difference voltage to the A/D converter 28. The first variable reference power supply EV1 can output the first reference voltage at any voltage, so that in this embodiment, the first reference voltage is set to an allowable output voltage Vomax of the power supply device 2. Accordingly, when an output voltage Vo between the higher-voltage output line 20a and the lower-voltage output line 20b exceeds the allowable output voltage Vomax, a binary-coded negative difference voltage is outputted to the feedback signal generation circuit 25.

The non-inverting input terminal of the current monitoring comparator 27 is connected to one end of the output current detection resistor 31 on the output terminal 2b side via the analog input terminal Is. Thus, the non-inverting input terminal is supplied with the voltage equivalent to the voltage drop which is caused by the output current flowing through the lower-voltage output line 20b that flows through the output current detection resistor 31. The second reference voltage outputted by the second variable reference power supply EV2 can also be varied to any voltage, so that in this embodiment, the second reference voltage is set to a voltage equal to the voltage drop across the output current detection resistor 31 when the allowable output current Iomax of the power supply device 2 flows between the output lines 20a and 20b. The current monitoring comparator 27 compares the potential at the analog input terminal Is with the second reference voltage which is set to a potential equivalent to the allowable output current Iomax and then outputs the difference voltage to the A/D converter 28. Thus, when the output current flowing between the output lines 20a and 20b exceeds the allowable output current Iomax, a binary-coded negative difference voltage corresponding to the exceeded current value is outputted to the feedback signal generation circuit 25.

The demodulation circuit 29 to serve as the power supply side receive means operates as a receive circuit for receiving, on the power supply device 2 side, the power-receive side information transmitted from the power receive device 3 via the power cable 5. The demodulation circuit 29 has a pair of input terminals D⁺ and D⁻ which are connected to the higher-voltage output line 20a and the lower-voltage output line 20b connected to the power cable 5 and through which a modulation signal superimposed on the output lines 20a and 20b is entered. The modulation signal supplied through the pair of input terminals D⁺ and D⁻ is demodulated at the demodulation circuit 29, so that the power-receive side information demodulated from the modulation signal is outputted to the feedback signal generation circuit 25.

The feedback signal generation circuit 25 generates a feedback signal that contains the difference voltage outputted from the A/D converter 28 and the power-receive side information outputted from the demodulation circuit 29, and then provides ON/OFF control to the photodiode 18 connected to the feedback output FB on the basis of the feedback signal. As described above, since the photodiode 18 is optically coupled to the phototransistor 19 on the primary side of the transformer 6, the feedback signal generated by the feedback signal generation circuit 25 is outputted to the feedback signal input circuit 12 on the primary side via the photo coupling elements 18 and 19.

The basic operation of the power supply device 2 will now be briefly described. The driver circuit 17 provides ON control to the switching element 8, so that the primary winding current Ip as a magnetizing current starts to flow through the primary winding 6a connected in series so as to produce induced electromotive force on each winding of the transformer 6.

At ON time T1 in time T1 after the ON control was provided, the driver circuit 17 provides ON control to the switching element 8. When the switching element 8 is turned OFF, the current flowing through the primary winding 6a is substantially interrupted, causing what is called the flyback voltage to occur across each of the windings 6a, 6b, and 6c of the transformer 6. At this time, the flyback voltage established across the secondary winding 6b is rectified and smoothed by the rectifier diode 23 and the smoothing capacitor 24 so as to output DC power to the load 4 of the power receive device 3 through the output lines 20a and 20b and the power cable 5.

The flyback voltage will disappear when the electrical energy accumulated on the secondary winding 6b is completely released due to the consumption of power by the load 4. Then, the series resonance of the stray capacitance of the primary winding 6a or the switching element 8, and the primary winding 6a causes oscillations to start, the amplitude of which will gradually decrease.

The voltage established across each of the windings will drop, and the driver circuit 17 provides ON control again to the switching element 8 after period T to turn ON the switching element 8. In this manner, the series of oscillatory operations is repeated.

Now, a description will be made to the method for providing an output current Io, which flows through the higher-voltage output line 20a and the lower-voltage output line 20b in the oscillatory operation, with constant-current control to have an arbitrary setting output current Iₒₛₑₜ. The output current Io is expressed by the average value of the secondary winding current Is flowing through the secondary winding 6b with oscillation period T:

Io=Isₘₐₓ×T2/T/2 (Equation 1)

where Isₘₐₓ is the peak current flowing through the secondary winding 6b, and T2 is the time during which the flyback voltage is established across the secondary winding 6b within the oscillation period T, i.e., the time during which the secondary winding current Is flows through the secondary winding 6b.

Furthermore, the primary winding current Ip and the secondary winding current Is have the following relation:

Np×Ip=Ns×Is (Equation 2)

where Np is the number of windings of the primary winding 6a and Ns is the number of windings of the secondary winding 6b. Thus, the relation below can be derived from Equation (2) as:

Isₘₐₓ=Ipₘₐₓ×Np/Ns (Equation 3)

where Ipₘₐₓ is the peak current flowing through the primary winding 6a.

Furthermore, the oscillation period T is expressed as:

T=T1+T2+T3 (Equation 4)

where T1 is the ON time of the switching element 8 which magnetizes the primary winding 6a, and T3 is the OFF control time. Substituting Equation (3) and Equation (4) into Equation (1) provides the relation below:

T3=T2×(Np/Ns×Ipₘₐₓ/2/Io−1)−T1 (Equation 5).

Here, the primary winding current Ip increases generally in proportion to the elapse of the ON time T1. Thus, letting the ON time T1 be a fixed value, the peak current Ipₘₐₓ of the primary winding is then a constant, and Np and Ns are each a constant that is determined by the circuit components. Accordingly, detecting T2 and substituting the values into Equation (5) allow the output current Io or an arbitrary output value to be obtained by adjusting the OFF control time T3. That is, to set the output current Io to the predetermined output current Iₒₛₑₜ, the output current Io of Equation (5) is replaced by the setting output current Iₒₛₑₜ, and after the elapse of time T2, the OFF control time T3 obtained from Equation (6) below is provided,

T3=T2×(Np/Ns×Ipₘₐₓ/2/Iₒₛₑₜ−1)−T1 (Equation 6).

This allows for the output current Io to be provided with constant-current control to have the setting output current Iₒₛₑₜ.

In the power supply device 2, the time T2 in each oscillation period T can be obtained by the potential and polarity at the analog input terminal Vs delivered from the flyback voltage detection circuit 14. Thus, the constant-voltage & constant-current control circuit 9 generates a switch control signal which contains the detected time T2, the setting output current Iₒₛₑₜ, and the OFF control time T3 determined by Equation (6), and then outputs the switch control signal to the driver circuit 17. Then, ON/OFF control is performed on the switching element 8 with the OFF control time T3 included in each oscillation period T, thus allowing the output current Io to be constant-current controlled at the setting output current Iₒₛₑₜ.

Now, a description will be made to the method for providing the output voltage Vo with constant-voltage output control to have an arbitrary setting output voltage Vₒₛₑₜ. In the oscillatory operation of the power supply device 2, the peak current Isₘₐₓ flowing through the secondary winding 6b can be expressed by:

Isₘₐₓ=Vs/Ls×T2 (Equation 7)

where Vs is the output voltage from the secondary winding 6b and Ls is the inductance of the secondary winding 6b. From Equation (7) above and Equation (3), the relation below can be obtained,

Ipₘₐₓ=Vs×Ns/Np/Ls×T2 (Equation 8).

The output voltage Vs from the secondary winding 6b is the output voltage Vo appearing between the output lines 20a and 20b, and Ns, Np, and Ls are each a constant to be determined by the circuit components. Thus, detecting T2 and substituting the values into Equation (8) allow an arbitrary output voltage Vo to be obtained by adjusting the primary winding peak current Ipₘₐₓ. In this context, the output voltage Vs in Equation (8) is replaced by the setting output voltage Vₒₛₑₜ to be constant-voltage controlled, and the switching element 8 is OFF-controlled when the primary winding current Ip has reached the primary winding peak current Ipₘₐₓ that is determined by Equation (9) below,

Ipₘₐₓ=Vₒₛₑₜ×Ns/Np/Ls×T2 (Equation 9).

This allows the output voltage Vo to be provided with constant-voltage output control so as to be at the setting output voltage Vₒₛₑₜ.

As described above, the power supply device 2 allows the potential and the polarity at the analog input terminal Vs outputted from the flyback voltage detection circuit 14 to provide time T2 in each oscillation period T. Thus, the constant-voltage & constant-current control circuit 9 calculates the primary winding peak current Ipₘₐₓ from the time T2, the setting output voltage Vₒₛₑₜ, and Equation (9), and then generates, for output to the driver circuit 17, a switch control signal which provides OFF-control to the switching element 8 with the timing at which the primary winding current Ip inputted from the primary-side current detection circuit 13 reaches the primary winding peak current Ipₘₐₓ that has been calculated. This causes the switching element 8 to be turned OFF in each oscillation period T when the primary winding current Ip has reached the calculated primary winding peak current Ipₘₐₓ and thus the primary winding current Ip is interrupted, whereby the output voltage Vo between the output lines 20a and 20b is provided with constant-voltage output control to have the setting output voltage Vₒₛₑₜ.

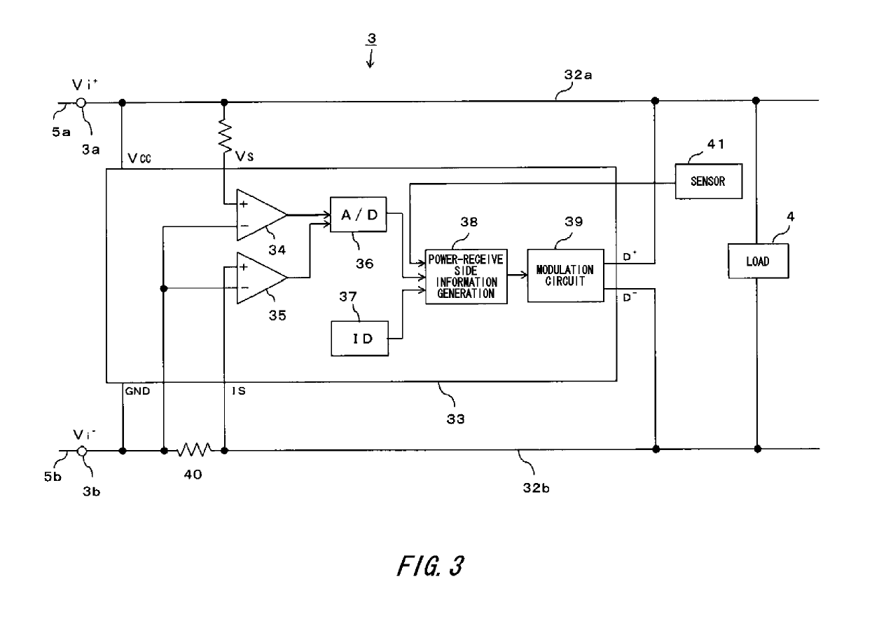

As shown in FIG. 3, the power receive device 3 has a pair of input terminals 3a and 3b which are connected to the higher-voltage connection line 5a and the lower-voltage connection line 5b of the power cable 5, respectively. The power receive device 3 includes a power-receive side control circuit element 33 which operates on the DC power to be supplied from the power supply device 2 between a higher-voltage power line 32a connected to the input terminal 3a and a lower-voltage power line 32b connected to the input terminal 3b, and an input current detection resistor 40 which is connected in series to the lower-voltage power line 32b and has a micro resistance value.

The power-receive side control circuit element 33 is an IC element that includes the following which are integrated into a one-chip circuit component: a voltage detection comparator 34 for detecting an input voltage Vi to be supplied from the power cable 5 to between the higher-voltage power line 32a and the lower-voltage power line 32b; a current detection comparator 35 for detecting an input current Ii flowing through the lower-voltage power line 32b; an A/D converter 36; an ID storage unit 37 for storing ID information of the power receive device 3; a power-receive side information generation circuit 38; and a modulation circuit 39 serving as the power-receive side transmission means.

The voltage detection comparator 34 compares the potential at the non-inverting input connected to the higher-voltage power line 32a via the analog input terminal Vs with the potential at the inverting input connected to the lower-voltage power line 32b. The comparator 34 then outputs the resulting difference voltage or the input voltage Vi between the power lines 32a and 32b to the A/D converter 36.

Furthermore, the current detection comparator 35 compares the potential at the non-inverting input connected to one end of the input current detection resistor 40 via the analog input terminal Is with the potential at the inverting input connected to the other end of the input current detection resistor 40. Then, the current detection comparator 35 outputs, to the A/D converter 36, the input current Ii which flows through the lower-voltage connection line 5b and is expressed by the voltage across the input current detection resistor 40.

The A/D converter 36 converts the input voltage Vi and the input current Ii inputted in analog form into binary-coded values so as to be processed in the power-receive side information generation circuit 38, which is made up of a microcomputer, and then outputs the resulting values to the power-receive side information generation circuit 38. The input of the power-receive side information generation circuit 38 is also connected to the ID storage unit 37 and to the output of a sensor 41 disposed in the vicinity of the load 4 in addition to the A/D converter 36. The power-receive side information generation circuit 38 is supplied with the ID information stored in the ID storage unit 37 for identifying the power receive device 3 as well as the environment value in the vicinity of the load 4 that is detected by the sensor 41. Here, the sensor 41 is an illuminometer for measuring the quantity of light, and the environment value to be inputted to the power-receive side information generation circuit 38 is the illuminance information which is obtained by binary-coding the quantity of light in the vicinity of the load 4.

The power-receive side information generation circuit 38 generates, at predetermined time intervals, the input voltage Vi, the input current Ii, the ID information, and the illuminance information, which are inputted thereto, and the power-receive side information that contains the input setting values which set the input voltage Vi and/or the input current Ii to a predetermined value. The information generation circuit 38 then outputs the resulting information to the modulation circuit 39. The input setting value is to be set on the power receive device 3 side on the basis of the input voltage Vi and/or the input current Ii that are required for the load 4 to operate in a normal condition. However, when being set by the power supply device 2, the input setting value is not to be contained in the power-receive side information. Upon reception of the power-receive side information from the power-receive side information generation circuit 38, the modulation circuit 39 outputs the modulation signal modulated on the basis of the power-receive side information to between the output terminals D⁺ and D⁻ to which the pair of the power lines 32a and 32b are connected, respectively, thereby transmitting the modulation signal to the demodulation circuit 29 of the power supply device 2 via the power cable 5 connected to the power lines 32a and 32b.

In this embodiment, the load 4 may be a lighting device for illuminating the vegetable that is grown in a greenhouse. The load 4 is connected between the higher-voltage power line 32a and the lower-voltage power line 32b and operates on the DC power supplied to between the power lines 32a and 32b from the power supply device 2. The load 4 is connected to the higher-voltage power line 32a and the lower-voltage power line 32b of the power receive device 3. However, the load 4 may be preferably disposed in the vicinity of the power receive device 3 in order to allow the input voltage supplied to the load 4 to be detected more accurately by the voltage detection comparator 34 of the power receive device 3. More preferably, the load 4 may be included in the power receive device 3.

On the other hand, since the unstable DC power supply 10 of the power supply device 2 is obtained by rectifying and smoothing the commercial AC power supply, the distance to the load 4 may possibly be long which is located at a desired position within the greenhouse. Thus, the power supply device 2 and the power receive device 3 are connected therebetween with a 10 m or longer power cable 5, so that the resistance value of the power cable 5, which increases in proportion to the length thereof, causes the input voltage Vi inputted to the power receive device 3 to be significantly reduced as compared to the output voltage Vo outputted from the power supply device 2.

The power supply system 1 provides the input voltage Vi and the input current Ii applied to the lighting device 4 with constant-voltage & constant-current control to have a predetermined setting input voltage Vᵢₛₑₜ and setting input current Iᵢₛₑₜ (input setting value), respectively, regardless of the length of the power cable 5 on the basis of the illuminance in the vicinity of the lighting device (load) 4 detected by the illuminometer (sensor) 41. Now, a description will be made to the operation thereof.

The total luminous flux emitted from the lighting device 4 increases or decreases depending on the input voltage Vi and the input current Ii. Accordingly, to allow the lighting device 4 to emit luminous flux under the optimum condition for the growth of vegetable, the setting input voltage Vᵢₛₑₜ and the setting input current Iᵢₛₑₜ to be set in response to the illuminance in the vicinity of the lighting device 4 are expressed and set in the form of the sequence control data, which varies with elapsed time. The resulting data is then stored in the storage unit 16 on the power supply device 2 side. That is, here, on the power supply device 2 side, the input setting values are set which are the control target values for the input voltage Vi and the input current Ii to be supplied to the power receive device 3. For example, the duration of daytime may be increased in order to accelerate the growth of vegetable. In this case, when the illuminance information detected by the illuminometer 41 is reduced to a certain value after sunset, the setting input voltage Vᵢₛₑₜ is raised for a certain period of time to increase the luminous flux from the lighting device 4. On the other hand, when sufficient illuminance cannot be obtained even during daytime due to rain or the like and thus the illuminance information detected by the illuminometer 41 is not increased to a certain value, the setting input voltage Vᵢₛₑₜ is raised so as to increase the luminous flux from the lighting device 4.

Suppose the illuminance information 1x detected by the illuminometer 41 shows that the input voltage Vi actually observed between the power lines 32a and 32b is lower than the setting input voltage Vᵢₛₑₜ expressed by the sequence control data stored in the storage unit 16. In this case, the power-receive side information generation circuit 38 generates, at predetermined time intervals, the power-receive side information which contains the illuminance information 1x outputted from the illuminometer 41, the input voltage Vi and the input current Ii inputted from the A/D converter 36, and the ID information. Then, the modulation circuit 39 transmits the modulation signal modulated on the basis of the power-receive side information to the demodulation circuit 29 of the power supply device 2 via the power cable 5.

The demodulation circuit 29 demodulates the power-receive side information from the modulation signal and then outputs the resulting signal to the feedback signal generation circuit 25. The output voltage Vo between the output lines 20a and 20b of the power supply device 2 and the output current Io flowing through the output lines 20a and 20b may be less than the allowable output voltage Vomax and the allowable output current Iomax, respectively. In this case, the difference voltage outputted from the A/D converter 28 to the feedback signal generation circuit 25 has a positive polarity. The feedback signal that includes the positive difference voltage and the power-receive side information is delivered to the constant-voltage & constant-current control circuit 9 via the photo coupling elements 18 and 19 which are optically coupled to each other and the feedback signal input circuit 12 on the primary side.

Upon reception of the feedback signal, the constant-voltage & constant-current control circuit 9 determines, on the basis of the polarity of the difference voltage included in the feedback signal, that the output voltage Vo between the output lines 20a and 20b of the power supply device 2 and the output current Io flowing through the output lines 20a and 20b can be controllably increased. The control circuit 9 also obtains, from the power-receive side information, the input voltage Vi and the input current Ii to the power receive device 3 which is identified by the ID information, and the illuminance information 1x in the vicinity of the lighting device 4 connected to the power receive device 3.

Furthermore, concerning the illuminance information lx, the constant-voltage & constant-current control circuit 9 refers to the sequence control data that is read from the storage unit 16. The control circuit 9 then compares the setting input voltage Vᵢₛₑₜ and the setting input current Iᵢₛₑₜ indicated by the sequence control data with the input voltage Vi and the input current Ii included in the power-receive side information. After that, the control circuit 9 adjusts the setting output voltage Vₒₛₑₜ and the setting output current Iₒₛₑₜ so that Viset and Iiset will agree with Vi and Ii, respectively, thereby controlling the oscillatory operation of the power supply device 2. Here, the input voltage Vi between the power lines 32a and 32b is lower than the setting input voltage Vᵢₛₑₜ. Thus, the constant-voltage & constant-current control circuit 9 generates the switch control signal for providing ON/OFF control to the switching element 8 and then outputs the resulting signal to the driver circuit 17 so that the input voltage Vi transmitted from the power receive device 3 is converged on the setting input voltage Vᵢₛₑₜ while the power supply device 2 repeats the continual oscillatory operation.

More specifically, so long as the input voltage Vi is lower than the setting input voltage Vᵢₛₑₜ, the setting output voltage Vₒₛₑₜ that is set at that point in time is increased. Then, the control circuit 9 generates a switch signal for providing OFF-control to the switching element 8 when the primary winding current Ip inputted from the A/D converter 15 has reached the primary winding peak current Ipₘₐₓ determined by Equation (8), thereby increasing the output voltage Vo between the output lines 20a and 20b. When the output voltage Vo between the output lines 20a and 20b of the power supply device 2 increases, the input voltage Vi increases above the input voltage Vi that was detected by the voltage detection comparator 34 before the control was provided, even in the presence of a voltage drop on the power cable 5. In contrast, when the input voltage Vi included in the power-receive side information has exceeded the setting input voltage Vᵢₛₑₜ, the setting output voltage Vₒₛₑₜ that is set at that point in time is lowered to decrease the output voltage Vo. The input voltage Vi is made lower than the input voltage Vi that was detected by the voltage detection comparator 34 before the control was provided.

When the power supply device 2 provides this control repeatedly to repeat the continual oscillatory operation, the input voltage Vi will be soon converged on the setting input voltage Vᵢₛₑₜ. When the input voltage Vi contained in the power-receive side information coincides with the setting input voltage Vᵢₛₑₜ, the constant-voltage & constant-current control circuit 9 of the power supply device 2 generates the switch control signal that maintains the setting output voltage Vₒₛₑₜ at that point in time, thereby allowing the input voltage Vi for the power receive device 3 to be provided with constant-voltage control to have the setting input voltage Vᵢₛₑₜ.

Furthermore, the input current Ii contained in the power-receive side information is compared with the setting input current Iᵢₛₑₜ expressed in the sequence control data concerning the illuminance information lx, and the setting output current Iₒₛₑₜ is adjusted by lowering the setting output current Iₒₛₑₜ, set at that point in time, when the input current Ii is higher than the setting input current Iᵢₛₑₜ and by raising the setting output current Iₒₛₑₜ when the input current Ii is lower than the setting input current Iᵢₛₑₜ. Then the control circuit 9 generates a switch signal to decrease or increase the output current Io. Here, the switch signal is to provide ON control to the switching element 8 upon elapse of the OFF control time T3 that is obtained from Equation (6) and the setting output current Iₒₛₑₜ. The OFF control time T3 starts at the time the flyback voltage disappears. The constant-voltage & constant-current control circuit 9 can start detection when the polarity of the potential at the analog input terminal Vs inputted from the A/D converter 15 is inverted from positive to negative.

In this embodiment, one power supply device 2 and one power receive device 3 are connected by the power cable 5. Thus, the output current Io flowing through the output lines 20a and 20 of the power supply device 2 is equal to the input current Ii flowing through the power lines 32a and 32b of the power receive device 3. The power supply device 2 repeats this control to provide the continual oscillatory operation repeatedly, whereby the input current Ii contained in the power-receive side information is converged on the setting input current Iᵢₛₑₜ and provided with constant-current control to have the setting input current Iᵢₛₑₜ.

Either the power supply device 2 or the power receive device 3 or both of them may be prepared in multiple and connected therebetween by a common power cable 5, in the case of which the output current Io flowing through each power supply device 2 and the input current Ii flowing through each power receive device 3 are different from each other. However, since the output current Io and the input current Ii are increased or decreased in sync with each other, the input current Ii flowing through each power receive device 3 can be employed as the setting input current Iᵢₛₑₜ to be set for the power receive device 3.

The setting input voltage Vᵢₛₑₜ and the setting input current Iᵢₛₑₜ expressed in the sequence control data are varied depending on the elapsed time or the illuminance information 1x contained in the power-receive side information. Thus, the constant-voltage & constant-current control circuit 9 generates a switch control signal by the aforementioned method for providing ON/OFF control to the switching element 8 so that the input voltage Vi and the input current Ii transmitted from the power receive device 3 are converged on the setting input voltage Vᵢₛₑₜ and the setting input current Iᵢₛₑₜ, which will vary, respectively. Then, the control circuit 9 allows the lighting device 4 to operate on the setting input voltage Vᵢₛₑₜ and the setting input current Iᵢₛₑₜ expressed by the sequence control data.

Furthermore, in the aforementioned control, an increase in the output voltage Vo or the output current Io may cause either Vo or Io to exceed the allowable output voltage Vomax or the allowable output current Iomax, in this case of which the A/D converter 28 outputs a binary-coded negative difference voltage to the feedback signal generation circuit 25. The constant-voltage & constant-current control circuit 9 stops generating the switch control signal while the feedback signal containing data indicative of the negative difference voltage is supplied, so as to stop the switching element 8 in an OFF operational state. As a result, the magnetizing energy accumulated on the transformer 6 is gradually consumed, so that the output voltage Vo and the output current Io will become less than the allowable output voltage Vomax and the allowable output current Iomax. Accordingly, it is possible to prevent the occurrence of excessive DC power in the power supply device 2.

The aforementioned power supply system 1 is configured such that the power receive device 3 connected to the load 4 transmits the power-receive side information through the power cable 5 to the power supply device 2. However, the power supply device 2 may also be provided with power supply side transmission means for transmitting the power supply side information produced by the power supply device 2 to the power receive device 3 via the power cable 5, while the power receive device 3 may be provided with power-receive side receive means for receiving the power supply side information via the power cable 5. This configuration can be employed to provide bidirectional communications between the power supply device 2 and the power receive device 3 via the power cable 5.

As described above, the power supply side information produced by the power supply device 2 can be sent to the power receive device 3 in this manner. For example, this allows the output capacity of the power supply device 2 and the predetermined input setting values of the input voltage or the input current to the power receive device 3 controlled by the power supply device 2 to be sent as the power supply side information to the power receive device 3, whereby the input setting values can be set with reference to the power supply side information received by the power receive device 3 side.

Furthermore, the load control information for controlling the operation of the load 4 connected to the power receive device 3 may be transmitted as the power supply side information to the power receive device 3, thereby allowing the power supply device 2 to control the operation of the load 4. In this case, when the power consumed by the power receive device 3 to be controlled by the input setting values exceeds the output capacity of the power supply device 2, the operation of the load 4 can be controlled to reduce the power consumption on the power receive device 3 side, thereby controlling the input voltage or the input current to the power receive device 3 with the input setting values that are re-set to within the output capacity of the power supply device 2.

Furthermore, suppose that a plurality of power receive devices 3 are connected to the power supply device 2. In this case, the load control information can be transmitted as the power supply side information along with the ID information for identifying the individual power receive devices 3. This allows for controlling the power consumed by each of the power receive devices 3, thereby adjusting the power consumed by all the power receive devices 3 to be less than the power outputted from the power supply device 2.

Furthermore, the present invention can be modified in a variety of ways without being limited to the aforementioned embodiment. For example, the aforementioned embodiment is configured such that the output values of the output voltage Vo and the output current Io to be outputted from the power supply device 2 to the power cable 5 are controlled by the constant-voltage & constant-current control circuit 9. However, control can also be provided by allowing the first reference voltage outputted by the first variable reference power supply EV1 and the second reference voltage outputted by the second variable reference power supply EV2, on the secondary side of the transformer 6, to be adjusted to the output voltage Vo by which the input voltage Vi is converged on the setting input voltage Vᵢₛₑₜ and to the voltage that represents the output current Io by which the input current Ii is converged on the setting input current Iᵢₛₑₜ, respectively.

Furthermore, the type and the number of the sensor 41 or the load 4 are not limited to those of the aforementioned embodiment. The sensor 41 may be a thermometer installed in the vicinity of vegetable being grown, and the load 4 may be a heater for raising the temperature in the vicinity of the vegetable, so that sequence control can be provided to the temperature in conjunction with or separately from the sequence control on the aforementioned illuminance.

Furthermore, in the aforementioned embodiment, the input voltage Vi and the input current Ii to the DC power supply for driving the load 4 are controlled to be the setting input voltage Vᵢₛₑₜ and the setting input current Iᵢₛₑₜ, respectively. However, the power supply system can also control either one of the input voltage Vi and the input current Ii to a predetermined value.

The present invention is applicable to a power supply system in which a power supply device for supplying DC power is connected by an arbitrary power cable to a power receive device to which a load is connected.

What is claimed is:

1. A power supply system, comprising:
a power supply device;
a power receive device; and
a power cable connected between the power supply device and the power receive device, the power supply system supplying power to a load connected to the power receive device through the power cable, wherein
the power receive device includes
input detection means for detecting an input voltage or an input current inputted through the power cable, and
power-receive side transmission means for transmitting the input voltage or the input current detected by the input detection means to the power supply device through the power cable as power-receive side information, and
the power supply device includes
power supply side receive means for receiving the power-receive side information through the power cable, and
an output control circuit for controlling, on the basis of the power-receive side information received by the power supply side receive means, an output value of the output voltage or the output current to be outputted to the power cable so that the input voltage or the input current to be inputted to the power receive device is converged on a predetermined input setting value.

2. The power supply system according to claim 1, wherein
the power supply device further includes power supply side transmission means for transmitting power supply side information to the power receive device through the power cable, and
the power receive device further includes power-receive side receive means for receiving the power supply side information through the power cable.

3. The power supply system according to claim 2, wherein
the power supply side information is load control information for controlling an operation of a load connected to the power receive device, and
the power receive device controls the operation of the load connected to the power receive device on the basis of the load control information received by the power-receive side receive means.

4. The power supply system according to claim 1, wherein
the power supply device is a DC-DC converter for supplying DC power to a load connected to the power receive device;
the power-receive side transmission means outputs, to the power cable, a modulation signal modulated on the basis of the power-receive side information; and
the power supply side receive means demodulates the power-receive side information from the modulation signal inputted through the power cable.

5. The power supply system according to claim 1, wherein
the power receive device allows the power-receive side transmission means to transmit an environment value of an installation location, the environment value being detected by a sensor disposed in the vicinity of the load and included in the power-receive side information; and
the output control circuit of the power supply device controls, on the basis of the power-receive side information containing the environment value, the output value of the output voltage or the output current so that the input voltage or the input current is converged on a predetermined input setting value.

6. The power supply system according to claim 5, wherein
the power supply device further includes storage means for storing control data for continually controlling the input setting value, and
the output control circuit of the power supply device controls the output value of the output voltage or the output current so that sequence control is provided on the basis of the control data to the input setting value of the input voltage or the input current.
